(19) United States
(12) Patent Application Publication
(10) Pub. No.: US 2020/0161801 A1
(43) Pub. Date: May 21, 2020

(54) CONNECTOR

(71) Applicant: IRISO ELECTRONICS CO., LTD., Yokohama-shi, Kanagawa (JP)

(72) Inventors: Ken Chiba, Yokohama-shi, Kanagawa (JP); Yasuyoshi Yoshikai, Yokohama-shi, Kanagawa (JP)

(21) Appl. No.: 16/617,489

(22) PCT Filed: Mar. 28, 2018
(86) PCT No.: PCT/JP2018/012981

§ 371 Date: Nov. 26, 2019

(30) Foreign Application Priority Data
May 30, 2017 (JP) 2017-106298

(51) Int. Cl. H01R 13/533; H01R 13/502; H01R 13/11

(52) U.S. Cl. CPC H01R 13/533; H01R 13/114; H01R 13/502

(57) ABSTRACT

A conncector includes an outer housing, an inner housing that is accommodated in the outer housing so as to be movable with respect to the outer housing in a predetermined movable region in a connector front-rear direction, and a terminal. The terminal includes a leading end portion, a base end portion, and a spring portion positioned between the leading end portion and the base end portion. The leading end portion includes a contact portion for connecting to a connection target, and a leading end side retained portion configured to be retained in the inner housing. The base end portion includes an electric cable connection portion (flexible wiring member connection portion) and a base end side retained portion configured to be retained in the outer housing.

### TECHNICAL FIELD

The present invention relates to a connector.

### BACKGROUND ART

Hitherto, connectors such as that disclosed in Patent Document 1 (see FIG. 8 and FIG. 9 thereof) have been employed for vehicle interior wiring connections and the like.

The connector (connector B) disclosed in Patent Document 1 includes a housing (first housing 60) and a terminal (first terminal fitting 70) that is accommodated inside the housing. One end (a terminal connection portion 71) of the terminal contacts a connection target (second terminal fitting 30), and the other end (electric cable connection portion 72) of the terminal is connected to an electric cable (electric cable 50). The housing is fitted together with a counterpart housing (second housing 20) in order to electrically connect the one end of the terminal to the connection target.

Patent Document 1: Japanese Patent Application Laid-Open (JP-A) No. 2004-241246

### SUMMARY OF INVENTION

### Technical Problem

However, such a connector presents the following issues.

Namely, since the housing is fitted together with the counterpart housing, play may be present between the housing and the counterpart housing. In such cases, there is a possibility that a contact point between the connection target retained in the counterpart housing and the terminal retained in the housing may slide (this is referred to hereafter as sliding of the contact point).

Moreover, since the electric cable (harness) connected to the other end of the terminal is flexible, the electric cable may flap. Such flapping of the electric cable may be transmitted so as to affect the terminal, causing sliding of the contact point.

Such sliding of the contact point may, for example, cause plating on the terminal and/or the connection target to flake off.

Moreover, in a connector such as that described above, the target for connection to the other end of the terminal may be a flexible printed circuit (FPC: a flexible printed wiring board or a flexible printed wiring board) or a flexible flat cable (FFC) (namely, the connector may be configured as an FPC connector or an FFC connector) instead of an electric cable. FPCs and FFCs have similar flexibility to an electric cable, and may flap. In such cases, similarly to in the case of an electric cable, such flapping may be transmitted so as to affect the terminal and cause sliding of the contact point.

In consideration of the above circumstances, an object of the present invention is to provide a connector capable of suppressing sliding of a contact point caused by the presence of play with respect to a counterpart housing or flapping of a flexible wiring member (electric cable, FPC, FFC, or the like).

### Solution to Problem

A connector according to a first aspect includes an outer housing that fits together with a counterpart housing configured to retain a connection target, an inner housing that is accommodated in the outer housing so as to movable with respect to the outer housing, in a predetermined movable region in a connector front-rear direction, and a terminal configured accommodated in the outer housing. The terminal includes a leading end portion, a base end portion, and a spring portion positioned between the leading end portion and the base end portion. The leading end portion includes a contact portion configured to contact the connection target, which is insertable and removable in the connector front-rear direction, and a leading end side retained portion configured to be retained in the inner housing. The base end portion includes a flexible wiring member connection portion that connects to a flexible wiring member, and a base end side retained portion configured to be retained in the outer housing.

In the connector according to the first aspect, in an electrically connected state of the terminal and the connection target, the outer housing and the counterpart housing are in a fitted state. There is a possibility that play may be present between the outer housing and the counterpart housing in the connector front-rear direction.

In the connector according to the first aspect, the leading end portion of the terminal includes the contact portion configured to contact the connection target that is insertable and removable in the connector front-rear direction, and the leading end side retained portion retained in the inner housing. Namely, the leading end portion of the terminal contacts the connection target and is also retained in the inner housing. The inner housing that retains the leading end portion is movable with respect to the outer housing, within a predetermined movable region in the connector front-rear direction.

Accordingly, even if play is present between the outer housing and the counterpart housing in the connector front-rear direction, the inner housing is movable with respect to the outer housing in the connector front-rear direction, thereby suppressing sliding of the contact point between the connection target and the contact portion.

Moreover, the base end portion of the terminal includes the flexible wiring member connection portion configured to connect to the flexible wiring member, and the base end side retained portion retained in the outer housing. Namely, the base end portion of the terminal is connected to the flexible wiring member (electric cable, FPC, FFC, or the like) and is also retained in the outer housing. Any flapping of the flexible wiring member is therefore transmitted so as to affect the base end portion of the terminal.

However, in the connector according to the first aspect, the terminal includes the spring portion positioned between the leading end portion and the base end portion.

Accordingly, even if the flapping of the flexible wiring member pushes in or tugs on the terminal, the spring portion positioned between the base end portion and the leading end portion undergoes elastic deformation, enabling the flapping of the flexible wiring member to be suppressed from affecting the leading end portion of the terminal. Sliding of the contact point caused by flapping of the flexible wiring member can thus be suppressed.

A connector according to a second aspect is the connector of the first aspect, wherein the outer housing includes a housing assembly opening formed at a connector rear side face of the outer housing and adjacent to a housing accommodation portion at which the inner housing is accommodated, and an anchor portion provided to the housing accommodation portion. The inner housing includes an anchored portion that undergoes elastic deformation in a case in which the inner housing is pushed toward the housing accommodation portion through the housing assembly opening, the elastic deformation being released upon reaching the anchor portion such that the anchored portion is anchored by the anchor portion, and the anchored portion limits a movement range of the inner housing in a connector rearward direction due to being anchored by the anchor portion.

In the connector according to the second aspect, during assembly of the connector the inner housing can be accommodated in the outer housing by pushing the inner housing toward the housing accommodation portion through the housing assembly opening formed at the connector rear side face of the outer housing.

When this is performed, the anchored portion of the inner housing initially undergoes elastic deformation, and when the anchored portion reaches the anchor portion formed in the housing accommodation portion, the elastic deformation is released such that the anchored portion is anchored by the anchor portion. Anchoring the anchored portion of the inner housing with the anchor portion of the outer housing limits the movement range of the inner housing in the connector rearward direction (namely, prevents the inner housing from coming out of the outer housing).

A connector according to a third aspect is the connector of either the first aspect or the second aspect, wherein the base end side retained portion is retained in the outer housing by being press-fitted into the outer housing, the base end side retained portion includes a press-fit shoulder that is pushed in toward the connector front from the connector rear during press-fitting of the base end side retained portion, and the base end side retained portion is positioned between the flexible wiring member connection portion and the spring portion.

In the connector according to the third aspect, the base end side retained portion is retained in the outer housing by being press-fitted into the outer housing. Note that it is necessary to push in the terminal using a tool or the like in order to press-fit the base end side retained portion into the outer housing.

In cases in which the flexible wiring member connection portion is configured by an electric cable connection portion, a configuration may be considered in which press-fitting is performed by pushing in the electric cable connection portion of the terminal. However, a portion (press-fit shoulder) of the electric cable connection portion that would be pressed if pushing in with a tool or the like would tend to be small, and would also be a portion where the electric cable connection portion is crimped to the electric cable, and therefore may not be flat. This would make accurate press-fitting difficult. Moreover, the crimped portion could be deformed or damaged during press-fitting.

Moreover, in cases in which the flexible wiring member connection portion is configured by something other than an electric cable connection portion, for example an FPC connection portion, a configuration may be considered in which press-fitting is performed by pushing in the FPC connection portion of the terminal. However, FPC connection portions are often portions that simply make elastic contact with the FPC, a configuration which is not well-suited to being pushed in with a tool or the like.

Accordingly, in the connector according to the third aspect, the base end side retained portion is positioned between the flexible wiring member connection portion and the spring portion, and the base end side retained portion includes the press-fit shoulder employed when pushing the base end side retained portion toward the connector front from the connector rear during press-fitting of the base end side retained portion. This enables the base end side retained portion to be press-fitted in an appropriate manner.

A connector according to a fourth aspect is the connector of the third aspect, wherein the outer housing includes a tool insertion hole that penetrates a bottom face of a base end accommodation portion that accommodates the base end portion, and that places the base end accommodation portion in communication with a space at an exterior of the outer housing.

The connector according to the fourth aspect facilitates press-fitting of the base end side retained portion into the outer housing.

Namely, in the connector according to the third aspect, in cases in which the flexible wiring member connection portion is configured by an electric cable connection portion, since the base end side retained portion is positioned between the electric cable electric cable connection portion and the spring portion, the electric cable connection portion would be liable to get in the way if attempting to push in the press-fit shoulder of the base end side retained portion from the electric cable side. Accordingly, in the connector according to the fourth aspect, the outer housing is provided with the tool insertion hole that penetrates the bottom face of the base end accommodation portion in which the base end portion is accommodated, and that places the base end accommodation portion in communication with a space at the exterior of the outer housing. Accordingly, inserting the tool or the like through the tool insertion hole enables the press-fit shoulder of the base end side retained portion to be pushed in without the electric cable connection portion getting in the way.

Note that in cases in which the flexible wiring member connection portion is configured by something other than an electric cable connection portion, for example an FPC connection portion, adopting the configuration of the fourth aspect may obviously be similarly understood in terms of facilitating press-fitting of the base end side retained portion into the outer housing.

A connector according to a fifth aspect is the connector of any one of the first aspect to the fourth aspect, wherein an insertion-removal axis of the contact portion is substantially parallel to a connection axis of the flexible wiring member connection portion, and is positionally offset from the connection axis of the flexible wiring member connection portion in a direction orthogonal to the connector front-rear direction.

In the connector according to the fifth aspect, the insertion-removal axis of the contact portion is substantially parallel to the connection axis of the flexible wiring member connection portion, and is positionally offset from the connection axis of the flexible wiring member connection portion in a direction orthogonal to the connector front-rear direction (namely orthogonal to the insertion-removal axis), thereby enabling an increase in a front-rear dimension of the connector to be suppressed while also securing the ease of deformation of the spring portion.

A connector according to a sixth aspect is the connector of the fifth aspect, wherein the spring portion includes a doubling-back portion that is doubled back in the connector rearward direction, which is an insertion direction of the connection target.

In the connector according to the sixth aspect, in addition to the insertion-removal axis and the connection axis of the flexible wiring member connection portion being offset in position from each other, the spring portion extending from the base end portion to the leading end portion is configured including the doubling-back portion doubled back in the connector rearward direction. This enables the ease of deformation of the spring portion to be even better secured.

### Advantageous Effects of Invention

As described above, the present invention exhibits the excellent advantageous effect of enabling sliding of a contact point caused by the presence of play with respect to the counterpart housing or flapping of the flexible wiring member to be suppressed.

### BRIEF DESCRIPTION OF DRAWINGS

FIG. 1 is an exploded perspective view illustrating a connector of an exemplary embodiment.

FIG. 2 is a perspective view illustrating an assembled state of terminals in an inner housing.

FIG. 3 is a perspective view illustrating a connector in an assembled state.

FIG. 4 is a perspective view illustrating a terminal connected to an electric cable.

FIG. 5 is a back view illustrating an assembled state of terminals in an inner housing (note that a terminal furthest to the left side is omitted from illustration).

FIG. 6 is a cross-section sectioned along line 6-6 in FIG. 5.

FIG. 7 is a side view cross-section illustrating the same state as FIG. 2.

FIG. 8 is a side view cross-section illustrating a connector in the same state as FIG. 3 (an assembled state).

FIG. 9 is a back view illustrating an outer housing.

FIG. 10 is a back view illustrating a connector in an assembled state.

FIG. 11 is an enlarged cross-section (a cross-section sectioned along line 11-11 in FIG. 8) illustrating an electric cable placement portion of an outer housing.

FIG. 12 is an enlarged cross-section (a cross-section sectioned along line 12-12 in FIG. 8) illustrating a terminal retention portion of an outer housing.

FIG. 13 is a side view cross-section illustrating a state in which a base end side retained portion of a terminal has been partially press-fitted.

FIG. 14 is a perspective view illustrating a state prior to fitting a connector and a counterpart housing together.

FIG. 15 is a perspective view illustrating a state in which a connector and a counterpart housing have been fitted together.

FIG. 16 is a perspective view illustrating a connector of another exemplary embodiment in an assembled state.

FIG. 17 is a perspective view illustrating a terminal of another exemplary embodiment.

FIG. 18 is a cross-sectional perspective view illustrating a connector of another exemplary embodiment in an assembled state.

FIG. 19 is a cross-section (corresponding to FIG. 18 as viewed from the side of the connector) illustrating a connector of another exemplary embodiment in an assembled state.

FIG. 20 is a back view illustrating an outer housing of another exemplary embodiment.

FIG. 21 is a back view illustrating a connector of another exemplary embodiment in an assembled state.

### DESCRIPTION OF EMBODIMENTS

Explanation follows regarding a connector 10 according to an exemplary embodiment of the present invention.

Connector 10

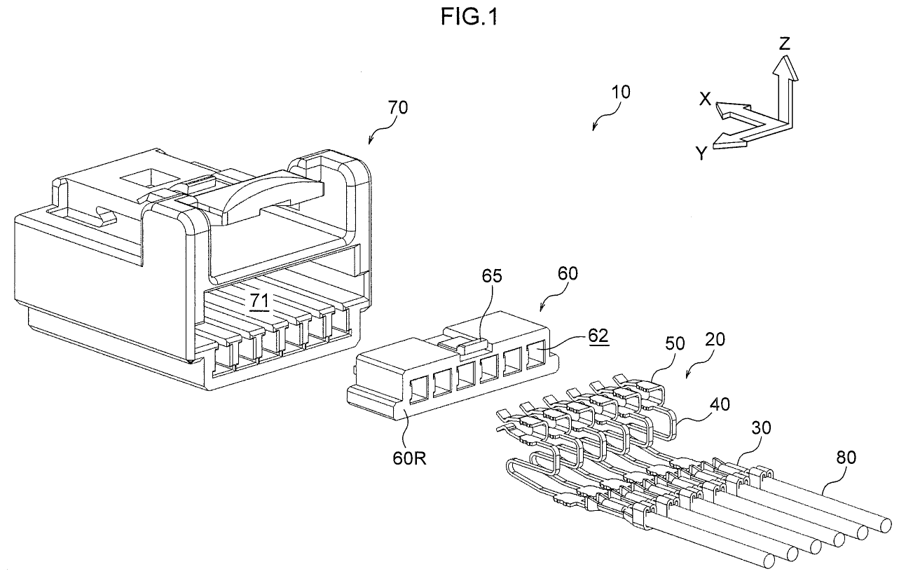

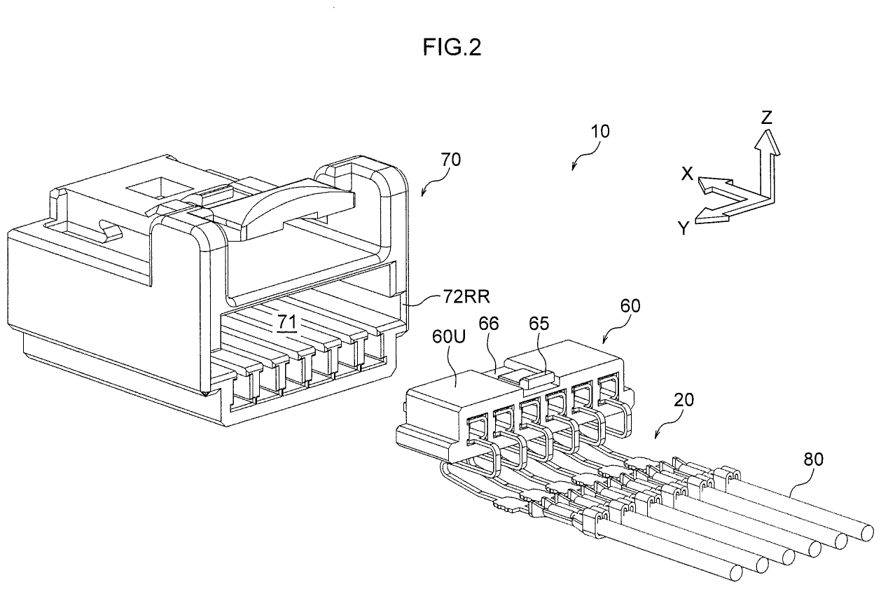

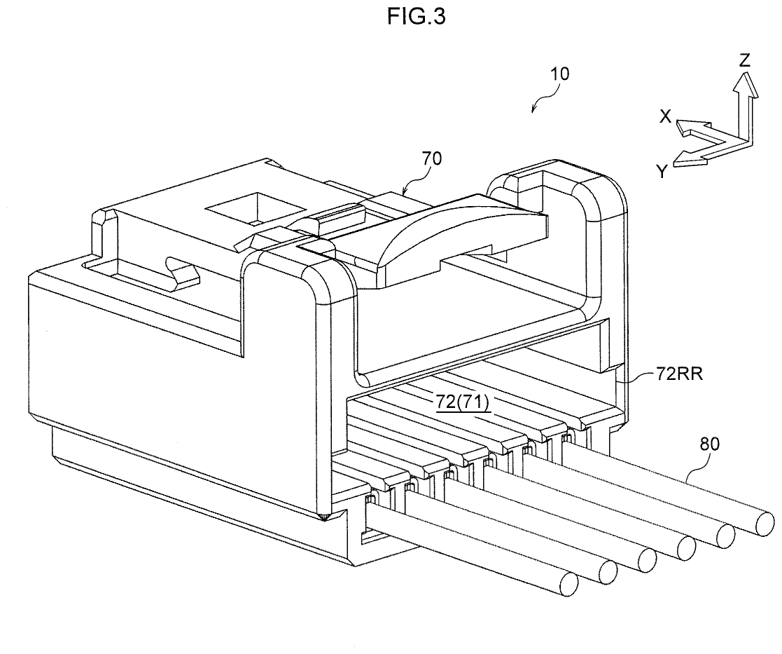

As illustrated in FIG. 1, the connector 10 of the present exemplary embodiment includes an outer housing 70, an inner housing 60, and plural (six) terminals 20. The connector 10 is assembled by assembling the plural terminals 20 to the inner housing 60 (see FIG. 2), and then assembling the terminals 20 and the inner housing 60 to the outer housing 70 (see FIG. 3).

Terminal 20

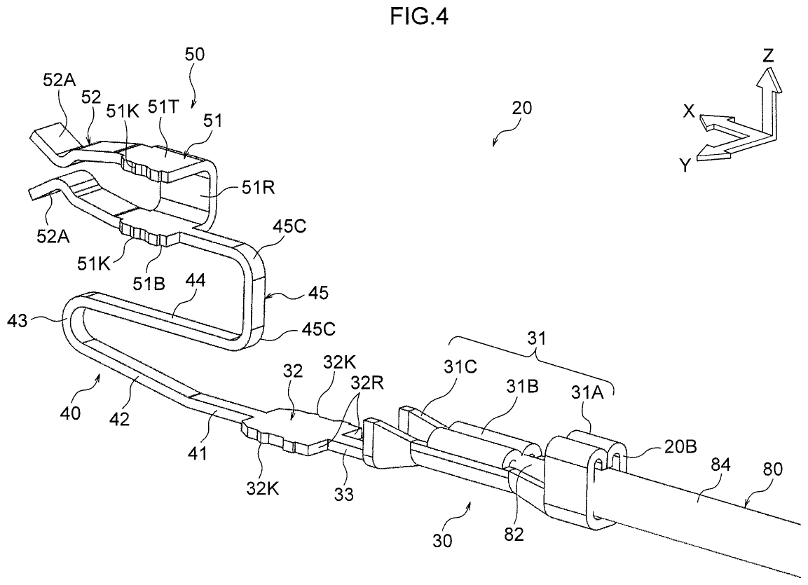

Explanation follows regarding the terminals 20. The plural terminals 20 are configured similarly to each other. One of the plural terminals 20 is illustrated in perspective view in FIG. 4. FIG. 4 illustrates the terminal 20 in a state connected to an electric cable 80.

In the following explanation regarding the terminal 20, the arrow X, the arrow Y, and the arrow Z illustrated in FIG. 4 respectively indicate a terminal forward direction, one side (a left side) in a terminal width direction, and a terminal upward direction. Unless specifically stated otherwise, reference to the front and rear, up and down, and width (left and right) is understood to refer to the front and rear in a terminal front-rear direction, up and down in a terminal up-down direction, and width (left and right) in the terminal width direction (left-right direction). In an assembled state of the connector 10, the front, rear, left, right, upward, and downward directions of the terminals 20 are substantially aligned with the front, rear, left, right, upward, and downward directions of the connector 10.

The terminals 20 are, for example, formed by punching and then bending a sheet material. The material employed for the terminals 20 is a material with electrically conductive properties, such as a copper alloy.

The terminal 20 includes a base end portion 30, a spring portion 40, and a leading end portion 50 in this sequence on progression from one end to the other end of the terminal 20.

Base End Portion 30

The base end portion 30 extends in a straight line toward the front from a rear end 20B of the terminal 20. The entire base end portion 30 is bent upward (toward a plate thickness direction inner face side) at both width direction sides. A cross-section profile of the base end portion 30 as sectioned orthogonally to the front-rear direction has an upward-opening U-shape or C-shape. The base end portion 30 includes an electric cable connection portion 31 and a base end side retained portion 32 in this sequence on progression from the one end side to the other end side.

The electric cable connection portion 31 is a portion for connecting to an electric cable 80 serving as a flexible wiring member, and corresponds to a flexible wiring member connection portion of the present invention. The electric cable connection portion 31 includes a sleeve press portion 31A that is pressed together with a sleeve 84 of the electric cable 80, and a core press portion 31B that is pressed together with a core 82 of the electric cable 80.

The electric cable connection portion 31 also includes a reinforcement portion 31C formed continuing from the other end side of the core press portion 31B. The reinforcement portion 31C has an upward-opening U-shaped cross-section profile, and reinforces the electric cable connection portion 31.

The base end side retained portion 32 is a portion configured to be retained in the outer housing 70. The base end side retained portion 32 is configured in a flat plate shape with a plate thickness direction oriented in the up-down direction, and is formed with an anchor protrusion 32K on each width direction side.

A coupling portion 33 couples the electric cable connection portion 31 and the base end side retained portion 32 together in the front-rear direction. The coupling portion 33 extends in a straight line along the front-rear direction and has a plate thickness direction oriented in the up-down direction. The coupling portion 33 has a uniform width dimension from one end to the other end. The width dimension of the coupling portion 33 is smaller than width dimensions of the electric cable connection portion 31 and the base end side retained portion 32, and specifically is a dimension of no greater than one third thereof.

The other end (front end) of the coupling portion 33 is joined to a width direction central portion of a rear end of the base end side retained portion 32. The rear end of the base end side retained portion 32A is thereby formed with a pair of left and right press-fit shoulders 32R. The pair of left and right press-fit shoulders 32R are respectively formed on the left and right of the coupling portion 33. The press-fit shoulders 32R are configured by faces that face in a terminal rearward direction, and the base end side retained portion 32 can be pushed toward the front in an appropriate manner by abutting a tool or the like against the press-fit shoulders 32R.

Spring Portion 40

The spring portion 40 is configured so as to undergo elastic deformation more readily than other locations. Elastic deformation of the spring portion 40 enables the leading end portion 50 to move relative to the base end portion 30 in the front, rear, left, right, upward, and downward directions.

The spring portion 40 of the present exemplary embodiment includes a first linear portion 41, an inclined portion 42, a first bent portion 43, a second linear portion 44, and a second bent portion 45 in this sequence on progression from one end side toward the other end side. The spring portion 40 has a uniform width dimension from the one end to the other end. This width dimension is smaller than a width dimension of the base end side retained portion 32, and is more specifically a dimension of no greater than one third of the width dimension of the base end side restricted portion 32.

The first linear portion 41 extends toward the front from a width direction central portion of a front end of the base end side retained portion 32. The plate thickness direction of the first linear portion 41 is oriented in the up-down direction, and the first linear portion 41 extends in a straight line toward the front from the one end toward the other end. The extension direction of the first linear portion 41 is parallel to the terminal front-rear direction. The other end side of the first linear portion 41 is joined to the inclined portion 42 through a kinked portion kinked slightly toward the plate thickness direction inner face side.

The plate thickness direction of the inclined portion 42 is substantially oriented in the up-down direction, and the inclined portion 42 extends in a straight line from one end to the other end in a direction inclined slightly upward with respect to the forward direction (an oblique direction running upward and toward the front). An angle formed between the extension direction of the inclined portion 42 and the terminal front-rear direction is less than 45°, and is set to approximately 20° in the present exemplary embodiment. An extension direction other end side of the inclined portion 42 is joined to the first bent portion 43.

The first bent portion 43 is bent toward the plate thickness direction inner face side, and has a curved profile protruding toward the front. The extension direction of the first bent portion 43 is transformed through approximately 160° between the one end and the other end thereof. The extension direction other end side of the first bent portion 43 is joined to the second linear portion 44.

The plate thickness direction of the second linear portion 44 is substantially oriented in the up-down direction, and the second linear portion 44 extends in a straight line toward the rear from one end to the other end. The extension direction of the second linear portion 44 is parallel to the terminal front-rear direction. The extension direction other end side of the second linear portion 44 is joined to the second bent portion 45.

The second bent portion 45 is bent toward the plate thickness direction outer face side, and has a rearward-protruding profile. Specifically, the second bent portion 45 is configured including two kinked portions 45C, each bent by approximately 90°. The extension direction of the second bent portion 45 is transformed through approximately 180° between one end and the other end thereof. The extension direction other end side of the second bent portion 45 is joined to the leading end portion 50.

Leading End Portion 50

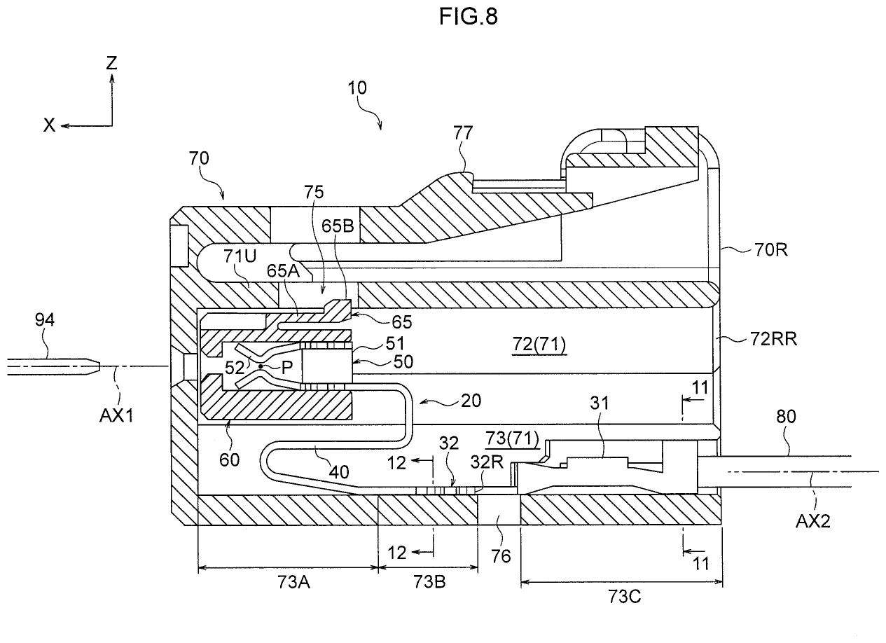

The leading end portion 50 includes a leading end side retained portion 51 and a contact portion 52. The leading end side retained portion 51 is a portion configured to be retained in the inner housing 60. The contact portion 52 is a portion configured to contact a connection target 94 (see FIG. 8).

The leading end side retained portion 51 has a substantially leftward-opening U-shaped cross-section profile (profile resembling three sides of a rectangle) as sectioned orthogonally to the front-rear direction. Specifically, the leading end side retained portion 51 is configured by a lower plate portion 51B, a right plate portion 51R extending upward from a right end of the lower plate portion 51B, and an upper plate portion 51T extending toward the left side from an upper end of the right plate portion 51R. A width direction central portion of a rear end of the lower plate portion 51B is joined to the spring portion 40. A width dimension of the leading end side retained portion 51 is larger than the width dimension of the spring portion 40, and is more specifically a dimension of at least three times that of the spring portion 40.

Anchor protrusions 51K are formed at a left end of the lower plate portion 51B of the leading end side retained portion 51 and at a left end of the upper plate portion 51T of the leading end side retained portion 51.

The contact portion 52 includes a pair of contact tabs 52A. Each of the pair of contact tabs 52A extends toward the front from the width direction center of either the upper plate portion 51T or the lower plate portion 51B of the leading end side retained portion 51. The pair of contact tabs 52A are configured to form an electrical connection between the terminals 20 and the connection target 94 forming a contact with the connection target 94 in the up-down direction.

Inner Housing 60

Explanation follows regarding the inner housing 60.

In the following explanation regarding the inner housing 60, the arrow X, the arrow Y, and the arrow Z respectively indicate an inner housing forward direction, one side (a left side) in an inner housing width direction, and an inner housing upward direction. Unless specifically stated otherwise, reference to the front and rear, up and down, and width (left and right) is understood to refer to the front and rear in an inner housing front-rear direction, up and down in an inner housing up-down direction, and width (left and right) in the inner housing width direction (left-right direction). In an assembled state of the connector 10, the front, rear, left, right, upward, and downward directions of the inner housing 60 are substantially aligned with the front, rear, left, right, upward, and downward directions of the connector 10.

As illustrated in FIG. 1 and FIG. 2, the inner housing 60 includes leading end accommodation portions 62 in which the leading end portions 50 of the respective terminals 20 are accommodated and retained. Plural (six) of the leading end accommodation portions 62 are provided, corresponding to the number of the terminals 20, and the leading end accommodation portions 62 are arranged along the width direction of the inner housing 60. The plural leading end accommodation portions 62 have the same structure as each other.

As illustrated in FIG. 1, each leading end accommodation portion 62 is configured by a space opening toward the rear in a rear face 60R of the inner housing 60. This opening portion is referred to as a leading end assembly opening. The leading end portion 50 of the terminal 20 can be accommodated in and retained in the leading end accommodation portion 62 of the inner housing 60 by assembling the leading end portion 50 of the terminal 20 into the leading end accommodation portion 62 through the leading end assembly opening (see FIG. 2).

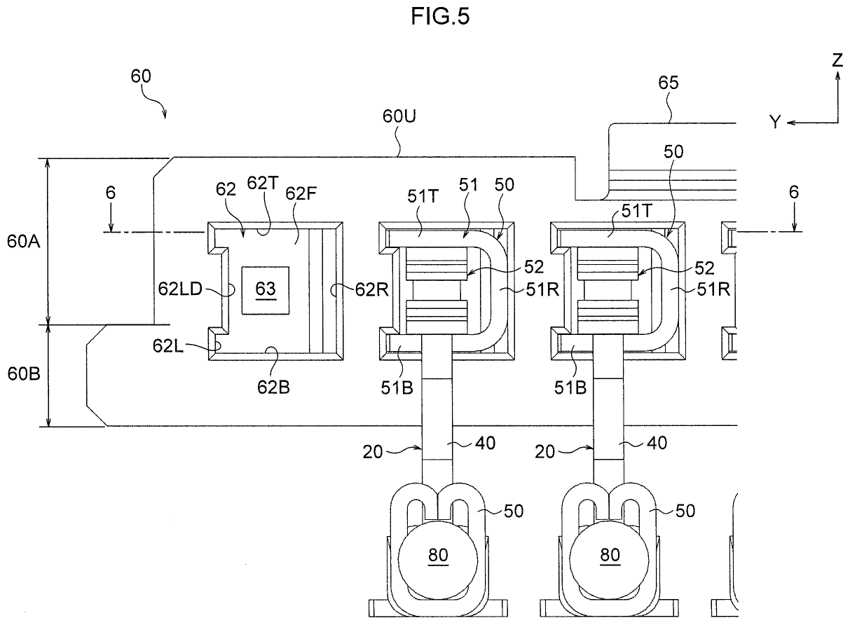

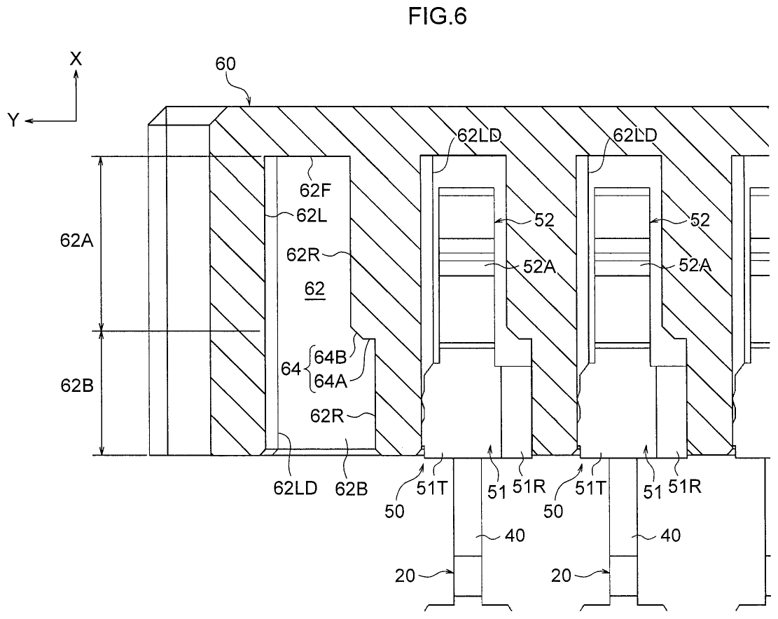

FIG. 5 is an enlarged view illustrating the inner housing 60 as viewed from the rear. FIG. 6 is a cross-section sectioned along line 6-6 in FIG. 5. Note that the terminal 20 corresponding to the leading end accommodation portion 62 furthest toward the left side out of the plural leading end accommodation portions 62 is omitted from illustration.

As illustrated in FIG. 5 and FIG. 6, each of the leading end accommodation portions 62 is configured by a substantially rectangular shaped space, and includes an upper wall 62T, a lower wall 62B, a left wall 62L, a right wall 62R, and a front wall 62F.

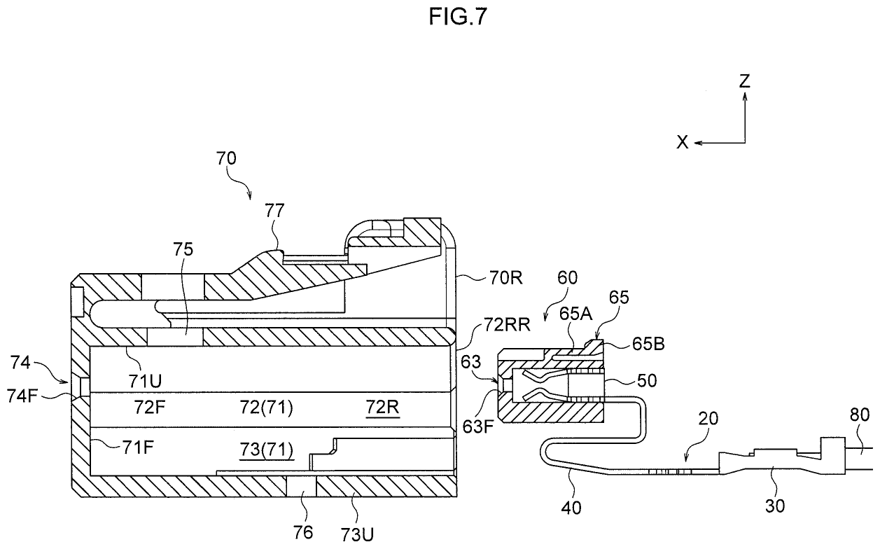

A connection target insertion hole 63 for insertion of the connection target 94 is formed in the front wall 62F. The connection target insertion hole 63 penetrates the front wall 62F in the front-rear direction, and has a rectangular shaped cross-section profile as sectioned orthogonally to the front-rear direction. As illustrated in FIG. 7, if the connection target insertion hole 63 is divided into a front portion and a rear portion, the front portion thereof is configured by a tapered portion 63F that becomes gradually wider on progression toward the front.

As illustrated in FIG. 5 and FIG. 6, the left wall 62L of the leading end accommodation portion 62 is formed with a projection 62LD projecting toward the right. The projection 62LD is a substantially rectangular block shaped portion projecting toward the right from a portion of the left wall 62L that does not include an upper end portion or a lower end portion of the left wall 62L. As illustrated in FIG. 6, the projection 62LD is formed spanning the entire leading end accommodation portion 62 in the front-rear direction, namely from the leading end assembly opening (rear end of the leading end accommodation portion 62) to the front wall 62F.

As illustrated in FIG. 5, in a state in which the leading end portion 50 of the terminal 20 is retained in the leading end accommodation portion 62, the left end of the upper plate 51T of the leading end side retained portion 51 of the terminal 20 is disposed at an upper side of the projection 62LD, and the left end of a lower plate 51B of the leading end side retained portion 51 of the terminal 20 is disposed at the lower side of the projection 62LD.

As illustrated in FIG. 6, the right wall 62R of each leading end accommodation portion 62 is formed with a step 64, such that a width dimension of the leading end accommodation portion 62 changes from front to rear about a boundary at the step 64. The width dimension of the leading end accommodation portion 62 at the front side of the step 64 (at a front portion 62A) is thus smaller, and the width dimension of the leading end accommodation portion 62 at the rear side of the step 64 (at a rear portion 62B) is larger.

More specifically, the step 64 is configured by a perpendicular face 64A connected perpendicularly to the right wall 62R of the rear portion 62B of the leading end accommodation portion 62, and an angled face 64B connected obliquely to the right wall 62R of the front portion 62A of the leading end accommodation portion 62. The angled face 64B is an oblique face forming a beveled face between the right wall 62R of the front portion 62A of the leading end accommodation portion 62 and the perpendicular face 64A.

In a state in which the leading end portion 50 of the terminal 20 is accommodated in the leading end accommodation portion 62, the right plate portion 51R of the leading end side retained portion 51 contacts the right wall 62R of the rear portion 62B of the leading end accommodation portion 62. Moreover, the anchor protrusions 51K of the upper plate portion 51T and the lower plate portion 51B of the leading end side retained portion 51 dig into the left wall 62L of the rear portion 62B of the leading end accommodation portion 62. The leading end side retained portion 51 is thus press-fitted into and retained in the inner housing 60.

As illustrated in FIG. 1 and FIG. 5, the inner housing 60 has a substantially rectangular block shaped external profile with its length in the width direction. More specifically, a lower portion of the inner housing 60 is formed with a greater width dimension than other portions thereof (portions at the upper side of the lower portion). In other words, the inner housing 60 is configured by a broad width portion 60B at a lower portion, and a general width portion 60A at portions other than the lower portion.

The inner housing 60 further includes an anchored portion 65 configured to be anchored by an anchor portion 75 of the outer housing 70, described later (see FIG. 7, FIG. 8).

The anchored portion 65 of the present exemplary embodiment is formed at a width direction central portion on an upper face 60U side of the inner housing 60. Specifically, as illustrated in FIG. 2, the upper face 60U of the inner housing 60 is formed with an indentation 66 indented downward at a width direction central position of the upper face 60U. The anchored portion 65 projects from a front-rear direction intermediate portion of the indentation 66. As illustrated in FIG. 7, the anchored portion 65 includes a spring tab 65A extending toward the rear, and a main body 65B formed to a leading end (rear end) of the spring tab 65A. The main body 65B is formed so as to project upward with respect to the spring tab 65A and the upper face 60U of the inner housing 60. When a downward load acts on the main body 65B, the spring tab 65A undergoes elastic deformation so as to displace the main body 65B downward.

Outer Housing 70

Explanation follows regarding the outer housing 70.

In the following explanation regarding the outer housing 70, the arrow X, the arrow Y, and the arrow Z respectively indicate an outer housing forward direction, one side (a left side) in an outer housing width direction, and an outer housing upward direction. Unless specifically stated otherwise, reference to the front and rear, up and down, and width (left and right) is understood to refer to the front and rear in an outer housing front-rear direction, up and down in an outer housing up-down direction, and width (left and right) in the outer housing width direction (left-right direction). The front, rear, left, right, upward, and downward directions of the outer housing 70 are aligned with the front, rear, left, right, upward, and downward directions of the connector 10.

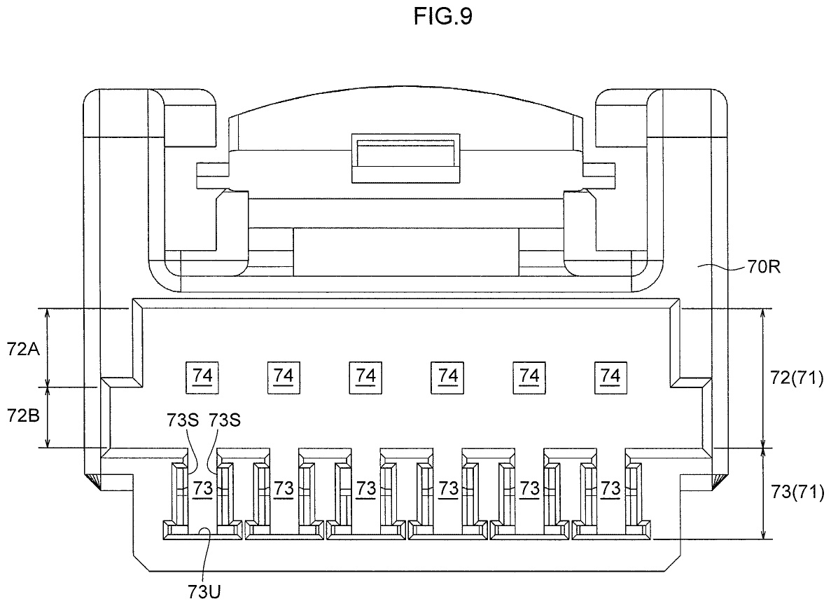

As illustrated in FIG. 7 and FIG. 9, the outer housing 70 includes an accommodation portion 71 configured by a rearward-opening space. The connector 10 is assembled by plugging in the inner housing 60 assembled with the plural terminals 20 toward the far end of the accommodation portion 71 through an opening portion in a rear face 70R of the outer housing 70.

As illustrated in FIG. 9, the accommodation portion 71 is configured by an upper accommodation portion 72 joined-up in the width direction, and a lower accommodation portion 73 partitioned into plural (six) spaces.

Upper Accommodation Portion 72

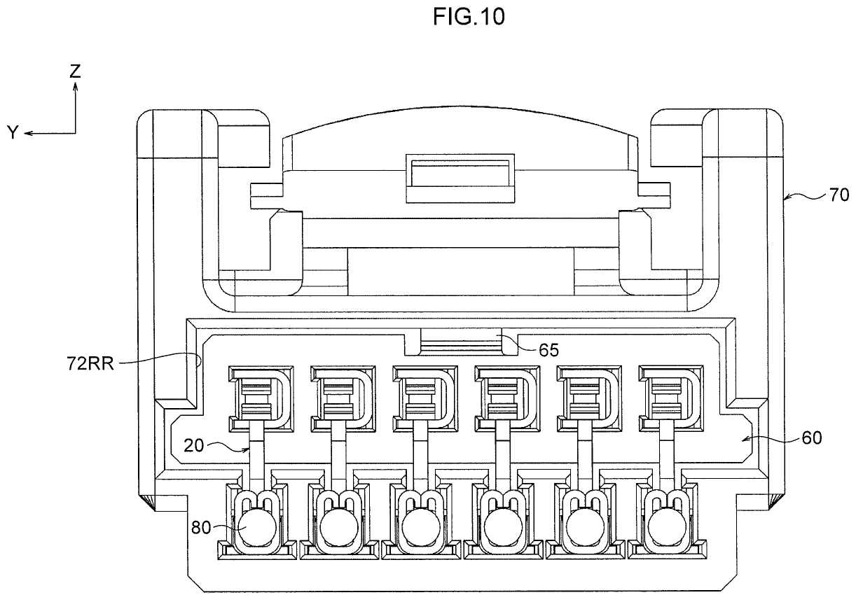

As illustrated in FIG. 8 and FIG. 10, the inner housing 60 is accommodated in the upper accommodation portion 72. Specifically, as illustrated in FIG. 7 and FIG. 8, the inner housing 60 is plugged in through a housing assembly opening 72RR at the rear end of the upper accommodation portion 72, passes through a rear portion 72R of the upper accommodation portion 72, and is accommodated in a front portion 72F of the upper accommodation portion 72. Namely, the front portion 72F of the upper accommodation portion 72 configures a housing accommodation portion 72F configured to accommodate the inner housing 60. Moreover, the rear portion 72R of the upper accommodation portion 72 configures a housing passage portion 72R through which the inner housing 60 passes.

As illustrated in FIG. 9 and FIG. 10, when the upper accommodation portion 72 is viewed from the rear side of the outer housing 70, the profile of the upper accommodation portion 72 resembles the profile of the inner housing 60 as viewed from the rear side. Namely, the upper accommodation portion 72 is configured by a general width portion 72A that the general width portion 60A of the inner housing 60 passes through and is accommodated in, and a broad width portion 72B that the broad width portion 60B of the inner housing 60 passes through and is accommodated in.

The upper accommodation portion 72 extends toward the front while maintaining the same profile as the housing assembly opening 72RR. Namely, the housing accommodation portion 72F configuring the front portion of the upper accommodation portion 72, the housing passage portion 72R configuring the rear portion of the upper accommodation portion 72, and the housing assembly opening 72RR configuring the rear end of the upper accommodation portion 72 all have substantially the same cross-section profile (cross-section profile as sectioned orthogonally to the front-rear direction). However, the housing assembly opening 72RR is formed with a tapered face (face with a beveled profile) in order to guide the inner housing 60.

A front wall 71F is formed at a front end of the accommodation portion 71. The front wall 71F is formed with plural (six) connection target insertion holes 74 at positions corresponding to the connection targets 94. The connection target insertion holes 74 penetrate the front wall 71F of the accommodation portion 71 in the front-rear direction. As illustrated in FIG. 7, if the connection target insertion holes 74 are divided into a front portion and a rear portion, the front portion of each is configured by a tapered face 74F that gradually widens on progression toward the front.

As illustrated in FIG. 10, an up-down dimension and a width dimension of the upper accommodation portion 72 are each formed slightly larger than the respective dimensions of the external profile of the inner housing 60. Accordingly, the up-down dimension and the width dimension of the housing accommodation portion 72F are also slightly larger than the respective dimensions of the external profile of the inner housing 60. The inner housing 60 is thus movable with respect to the outer housing 70 within a predetermined movable region in the up-down direction and the width direction.

Anchor Portion 75

As illustrated in FIG. 7 and FIG. 8, the anchor portion 75 is formed at the front portion of the upper accommodation portion 72 (in the housing accommodation portion 72F). The anchor portion 75 is configured by a hole penetrating (a width direction central position of) an upper wall 71U of the housing accommodation portion 72F in the up-down direction.

In a state in which the inner housing 60 is accommodated in the outer housing 70, the main body 65B of the anchored portion 65 of the inner housing 60 is disposed within the anchor portion 75. Accordingly, if the inner housing 60 moves toward the rear, the main body 65B of the anchored portion 65 abuts the anchor portion 75. Namely, the anchored portion 65 is anchored by the anchor portion 75, thus limiting a movement range of the inner housing 60 in the rearward direction. Namely, the inner housing 60 is prevented from coming out from the outer housing 70.

Conversely, if the inner housing 60 moves toward the front, the inner housing 60 abuts the front wall 71F of the accommodation portion 71. A movement range of the inner housing 60 toward the front is thus limited.

As a result, the inner housing 60 is movable with respect to the outer housing 70 within a predetermined movable region in the front-rear direction.

As illustrated in FIG. 8 and FIG. 10, in a free state in which the connection target 94 has not been connected (referred to hereafter as the free state), the inner housing 60 is placed in a floating state inside the upper accommodation portion 72 by the terminals 20. In other words, in the free state, the inner housing 60 is positioned at an intermediate position in the movable region, and is movable in any direction out of up, down, left, right, forward, or rearward.

Lower Accommodation Portion 73

As illustrated in FIG. 9, the lower accommodation portion 73 is configured by plural (six) terminal accommodation portions 73 (having the same reference numeral as the lower accommodation portion 73) arranged along the width direction. The plural terminal accommodation portions 73 are partitioned from each other and have the same structure as each other.

Each of the terminal accommodation portions 73 is configured by a space opening upward onto the upper accommodation portion 72 side and extending in the front-rear direction, and includes a bottom wall 73U and a pair of left and right side walls 73S.

As illustrated in FIG. 8, on progression from the rear toward the front, the electric cable 80, the electric cable connection portion 31 of the terminal 20, the base end side retained portion 32, and the spring portion 40 are disposed in this sequence inside the corresponding terminal accommodation portion 73 that extends in the front-rear direction.

The electric cable 80 and the electric cable connection portion 31 are disposed in a rear portion (electric cable placement portion 73C) of the terminal accommodation portion 73.

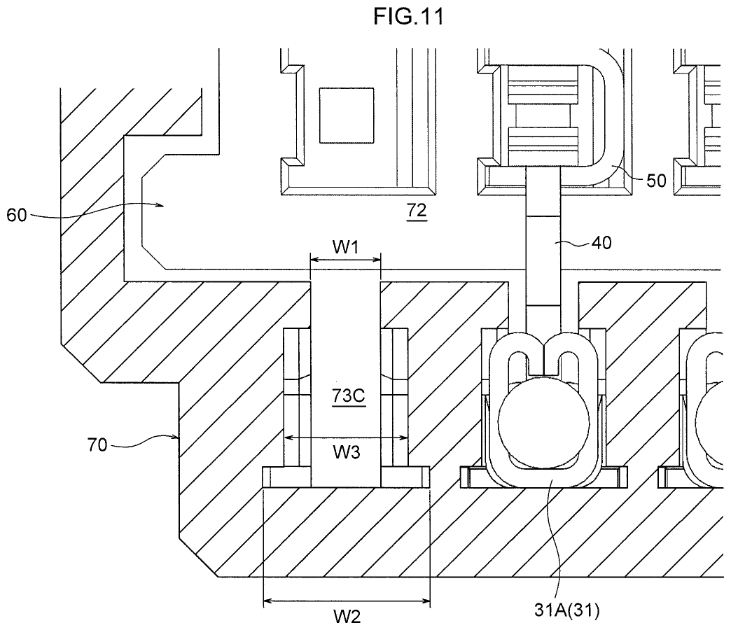

FIG. 11 is a cross-section sectioned along line 11-11 in FIG. 8. As illustrated in FIG. 11, a width dimension W1 of an upper end portion of the electric cable placement portion 73C is formed smaller than the width dimension of the electric cable connection portion 31 of the terminal 20, and the electric cable connection portion 31 is disposed in a portion at the lower side of the upper end portion of the electric cable placement portion 73C. Moreover, the width dimension W1 of the upper end portion of the electric cable placement portion 73C is formed larger than the width dimension of the spring portion 40. Accordingly, (the second bent portion 45 of) the spring portion 40 is capable of passing through the upper end portion of the electric cable placement portion 73C in the front-rear direction.

A width dimension W2 of a lower end portion of the electric cable placement portion 73C is wider than a width dimension W3 of an up-down direction intermediate portion of the electric cable placement portion 73C. The width dimension W2 is larger than the width dimension of the base end side retained portion 32 including the anchor protrusions 32K. The base end side retained portion 32 that has a greater width dimension than the electric cable connection portion 31 is thus capable of passing through the lower end portion of the electric cable placement portion 73C in the front-rear direction.

The base end side retained portion 32 of the terminal 20 is retained in a front-rear direction intermediate portion (terminal retention portion 73B) of the terminal accommodation portion 73.

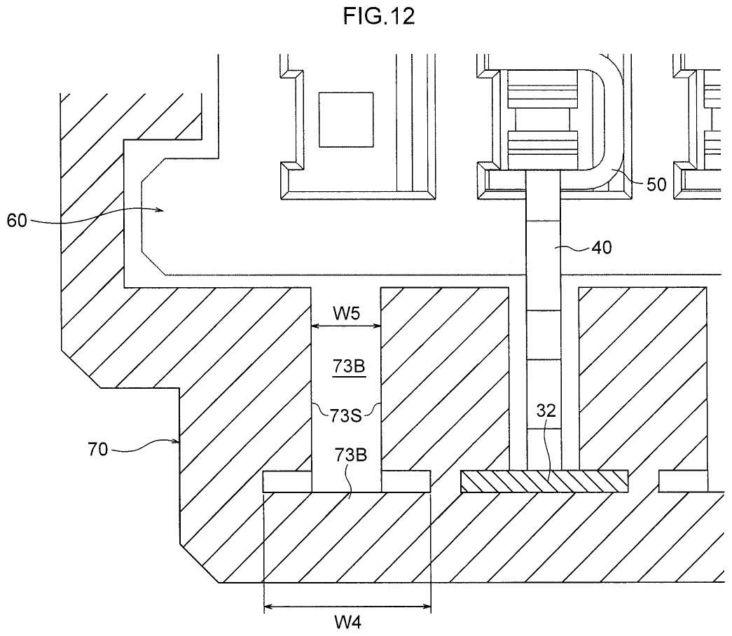

FIG. 12 is a cross-section sectioned along line 12-12 in FIG. 8. As illustrated in FIG. 12, a width dimension W4 of a lower end portion of the terminal retention portion 73B is narrower than the width dimension W2 (see FIG. 11) of the lower end portion of the electric cable placement portion 73C, and the width dimension W4 is smaller than the width dimension of the base end side retained portion 32 including the anchor protrusions 32K. Accordingly, when the base end side retained portion 32 is pushed into the lower end portion of the terminal retention portion 73B, the anchor protrusions 32K dig into the left and right side walls 73S at the lower end portion of the terminal retention portion 73B. The base end side retained portion 32 is press-fitted into the outer housing 70 in this manner.

A width dimension W5 of the electric cable placement portion 73C at the upper side of the lower end portion is a dimension that allows the spring portion 40 to pass through in the front-rear direction, and more specifically, is the same as the width dimension W1 of the upper end portion of the electric cable placement portion 73C.

The spring portion 40 of the terminal 20 is disposed in a front portion (spring placement portion 73A) of the terminal accommodation portion 73. The spring placement portion 73A is formed with the same width dimension from a lower end to an upper end, this width dimension being the same as the width dimension W5 of the electric cable placement portion 73C (excluding the lower end thereof), and the width dimension W1 of the upper end portion of the electric cable placement portion 73C.

Tool Insertion Hole 76

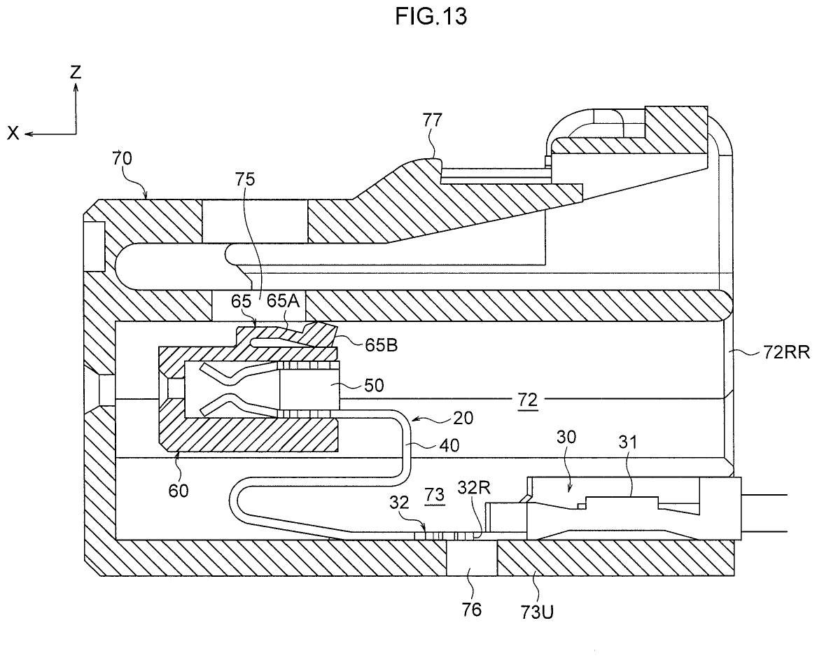

As illustrated in FIG. 8, the bottom wall 73U of the lower accommodation portion 73 is formed with a tool insertion hole 76 penetrating the bottom wall 73U in the up-down direction. The tool insertion hole 76 is formed immediately to the rear of the terminal retention portion 73B and immediately to the front of the electric cable placement portion 73C. A tool is inserted into the terminal retention portion 73B through the tool insertion hole 76 in a state in which the base end side retained portion 32 of the terminal 20 has been partially press-fitted therein as illustrated in FIG. 13, enabling the tool to push in the press-fit shoulders 32R of the base end side retained portion 32.

Fitting of Counterpart Housing 92

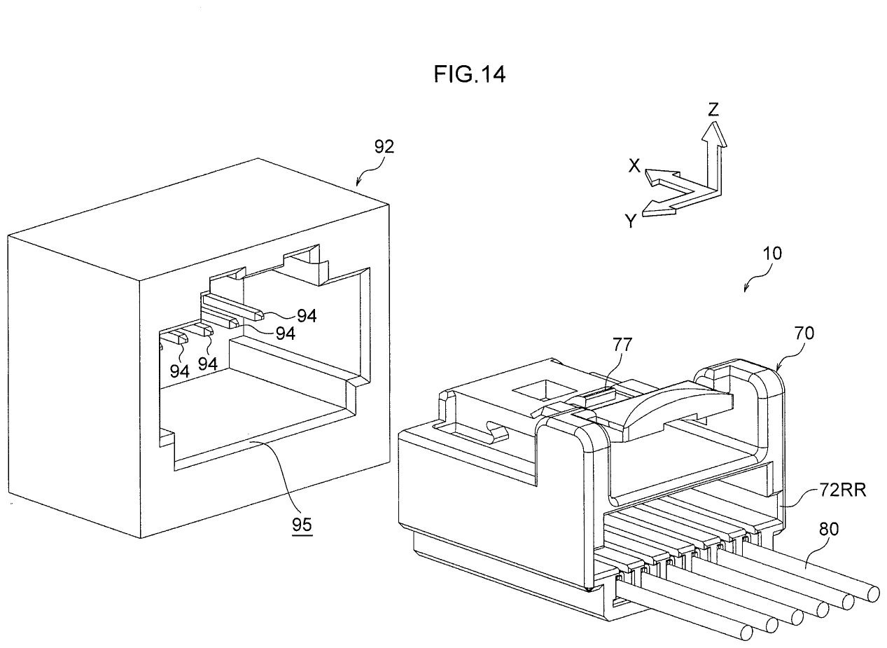

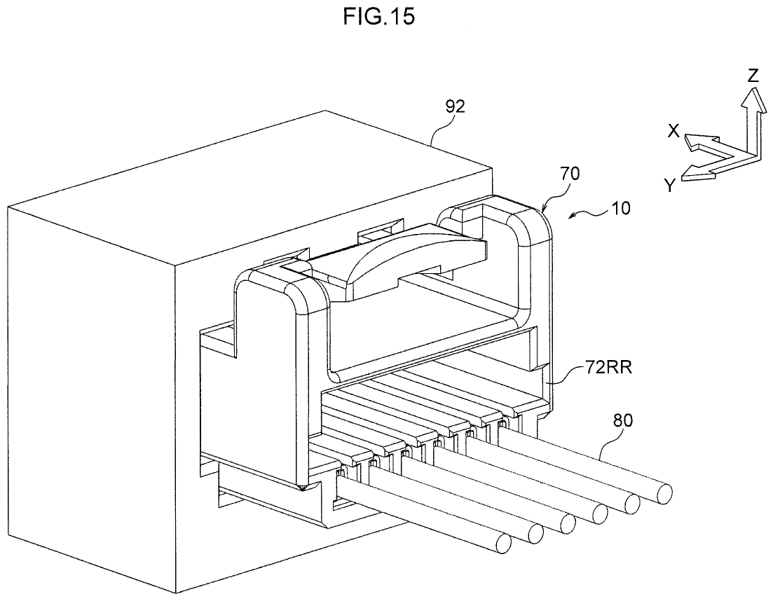

As illustrated in FIG. 14 and FIG. 15, the outer housing 70 is configured to fit together with counterpart housing 92 in which the connection target 94 is retained. Specifically, an anchored portion 77 is formed at an upper face side of the outer housing 70, and when the outer housing 70 is plugged into a fitting opening 95 in the counterpart housing 92 from a front face side, as illustrated in FIG. 15, the outer housing 70 fits together with the counterpart housing 92. The plural connection targets 94 and the plural terminals 20 are thereby electrically connected.

Operation and Advantageous Effects

Explanation follows regarding operation and advantageous effects of the present exemplary embodiment.

In the connector 10 according to the present exemplary embodiment, in an electrically connected state of the terminals 20 and the connection targets 94, the outer housing 70 and the counterpart housing 92 are in a fitted state as illustrated in FIG. 15. There is a possibility that play may be present between the outer housing 70 and the counterpart housing 92.

Note that as illustrated in FIG. 4, in the connector 10 according to the present exemplary embodiment, the leading end portion 50 of each of the terminals 20 includes the contact portion 52 configured to contact the connection target 94 that is insertable and removable along a connector front-rear direction, and the leading end side retained portion 51 retained in the inner housing 60. Namely, the leading end portion 50 of the terminal 20 contacts the connection target 94 and is also retained in the inner housing 60. As illustrated in FIG. 8 and FIG. 10, the inner housing 60 that retains the leading end portion 50 is movable with respect to the outer housing 70 within a predetermined movable region in the front-rear direction, left-right direction, and up-down direction of the connector.

Accordingly, even if play is present between the outer housing 70 and the counterpart housing 92, the inner housing 60 is movable with respect to the outer housing 70, thereby suppressing sliding of the contact point between the connection target 94 and the contact portion 52.

Moreover, the base end portion 30 of the terminal 20 includes the electric cable connection portion 31 configured to connect to the electric cable 80, and the base end side retained portion 32 retained in the outer housing 70. Namely, the base end portion 30 of the terminal 20 is connected to the electric cable 80 and is also retained in the outer housing 70. Any flapping of the electric cable 80 is therefore transmitted so as to affect the base end portion 30 of the terminal 20.

However, in the connector 10 according to the present exemplary embodiment, the terminal 20 includes the spring portion 40 positioned between the leading end portion 50 and the base end portion 30.

Accordingly, even if the flapping of the electric cable 80 pushes in or tugs on the terminal 20, the spring portion 40 positioned between the base end portion 30 and the leading end portion 50 undergoes elastic deformation, enabling the flapping of the electric cable 80 to be suppressed from affecting the leading end portion 50 of the terminal 20. Sliding of the contact point caused by flapping of the electric cable 80 can thus be suppressed.

In the connector 10 according to the present exemplary embodiment, as illustrated in FIG. 7 and FIG. 8, during assembly of the connector 10, the inner housing 60 can be accommodated in the outer housing 70 by pushing the inner housing 60 toward the housing accommodation portion 72F through the housing assembly opening 72RR formed in the connector rear side face (rear face 70R) of the outer housing 70.

When this is performed, the anchored portion 65 of the inner housing 60 initially undergoes elastic deformation (see FIG. 13), and when the anchored portion 65 reaches the anchor portion 75 formed in the housing accommodation portion 72F, the elastic deformation is released such that the anchored portion 65 is anchored by the anchor portion 75. Anchoring the anchored portion 65 of the inner housing 60 with the anchor portion 75 of the outer housing 70 limits the movement range of the inner housing 60 in a connector rearward direction (namely, prevents the inner housing 60 from coming out of the outer housing 70).

In the connector 10 according to the present exemplary embodiment, the base end side retained portion 32 is retained in the outer housing 70 by being press-fitted into the outer housing 70. Note that it is necessary to push in the terminal 20 using a tool or the like in order to press-fit the base end side retained portion 32 into the outer housing 70.

A configuration may be considered in which press-fitting is performed by pushing in the electric cable connection portion 31 of the terminal 20. However, the portions (press-fit shoulders) of the electric cable connection portion 31 that would be pressed if pushing in with a tool or the like would tend to be small, and would also be portions where the electric cable connection portion 31 is crimped to the electric cable 80, and therefore may not be flat. This would make accurate press-fitting difficult. Moreover, the crimped portion could be deformed or damaged during press-fitting.

Accordingly, in the connector 10 according to the present exemplary embodiment, the base end side retained portion 32 is positioned between the electric cable connection portion 31 and the spring portion 40, and the base end side retained portion 32 includes the press-fit shoulders 32R employed when pushing the base end side retained portion 32 toward the connector front from the connector rear during press-fitting of the base end side retained portion 32. This enables the base end side retained portion 32 to be press-fitted in an appropriate manner.

The connector 10 according to the present exemplary embodiment facilitates press-fitting of the base end side retained portion 32 into the outer housing 70.

Namely, in the connector 10 according to the present exemplary embodiment, since the base end side retained portion 32 is positioned between the electric cable connection portion 31 and the spring portion 40, the electric cable connection portion 31 would be liable to get in the way if attempting to push in the press-fit shoulders 32R of the base end side retained portion 32 from the electric cable 80 side. Accordingly, in the connector 10 according to the present exemplary embodiment, the outer housing 70 is provided with the tool insertion hole 76 that penetrates the bottom face (bottom wall 73U) of a base end accommodation portion (a portion encompassing the electric cable placement portion 73C and the terminal retention portion 73B) in which the base end portion 30 is accommodated, and that places the base end accommodation portion in communication with a space at the exterior of the outer housing 70. Accordingly, inserting the tool or the like through the tool insertion hole 76 enables the press-fit shoulders 32R of the base end side retained portion 32 to be pushed in without the electric cable connection portion 31 getting in the way.

In the connector 10 according to the present exemplary embodiment, as illustrated in FIG. 8, an insertion-removal axis AX1 of the contact portion 52 is substantially parallel to an electric cable connection axis AX2 of the electric cable connection portion 31 (a connection axis of the flexible wiring member connection portion), and is offset in position from the electric cable connection axis AX2 in a direction orthogonal to the connector front-rear direction, thereby enabling an increase in a front-rear dimension of the connector 10 to be suppressed while also securing the ease of deformation of the spring portion 40. Moreover, the direction in which the insertion-removal axis AX1 and the electric cable connection axis AX2 are offset from each other is a direction (connector up-down direction) orthogonal to an array direction of the plural terminals 20 (connector width direction), thereby enabling an increase in the width dimension of the connector 10 to be suppressed.

In the connector 10 according to the present exemplary embodiment, in addition to the insertion-removal axis AX1 and the electric cable connection axis AX2 being offset in position from each other, the spring portion 40 extending from the base end portion 30 to the leading end portion 50 is configured including a doubling-back portion (configured by the first bent portion 43, the second linear portion 44, and the second bent portion 45) doubled back in the connector rearward direction. This enables the ease of deformation of the spring portion 40 to be even better secured.

In the present exemplary embodiment, a connector forward direction end portion (the first bent portion 43) of the doubling-back portion extends toward the connector front side by a similar amount to a contact point P (see FIG. 8) of the contact portion 52 of the terminal 20, enabling the deformation of the spring portion 40 to be secured even more easily. Moreover, a connector rearward direction end portion (the second bent portion 45) of the doubling-back portion of the terminal 20 is disposed further toward the rear side than the inner housing 60. The overall length of the spring portion 40 can thus be set even longer, thereby enabling the ease of deformation of the spring portion 40 can be secured even more easily.

Supplementary Explanation to the above Exemplary Embodiment

In the exemplary embodiment described above, explanation has been given regarding an example in which the base end side retained portion 32 of the terminal 20 is retained by being press-fitted into the outer housing 70. However, the present invention is not limited thereto, and another retention method may be employed. Moreover, explanation has been given regarding an example in which the leading end side retained portion 51 of the terminal 20 is retained by being press-fitted into the inner housing 60. However, the present invention is not limited thereto, and another retention method may be employed.

In the exemplary embodiment described above, explanation has been given regarding an example in which the inner housing 60 is movable with respect to the outer housing 70 in a predetermined movable region in the connector front-rear direction, left-right direction, and up-down direction in a state in which the inner housing 60 is accommodated in the outer housing 70. However, the present invention is not limited thereto. It is sufficient that the inner housing is movable with respect to the outer housing in at least the connector front-rear direction, and configuration may be made in which the inner housing is effectively unable to move with respect to the outer housing in the connector up-down direction or the connector left-right direction.

In the exemplary embodiment described above, explanation has been given regarding an example in which the insertion-removal axis AX1 and the electric cable connection axis AX2 are offset in position from each other in the connector up-down direction. However, the present invention is not limited thereto, and the insertion-removal axis AX1 and the electric cable connection axis AX2 may be offset in position from each other in the connector width direction (the array direction of the plural terminals). Alternatively, for example, the insertion-removal axis AX1 and the electric cable connection axis AX2 may be disposed substantially along the same straight line.

In the exemplary embodiment described above, explanation has been given regarding an example in which the tool is inserted through the tool insertion hole 76 in a state in which the base end side retained portion 32 of the terminal 20 has been partially press-fitted into the terminal retention portion 73B, and the tool is used to push in the press-fit shoulders 32R of the base end side retained portion 32. However, for example, configuration may be made in which the tool insertion hole 76 is formed extending significantly further toward the rear than in the exemplary embodiment, such that the tool inserted through the tool insertion hole 76 can be used to push in the press-fit shoulders 32R of the base end side retained portion 32 even in a state in which the base end side retained portion 32 has not been press-fitted into the terminal retention portion 73B at all.

### Other Exemplary Embodiment

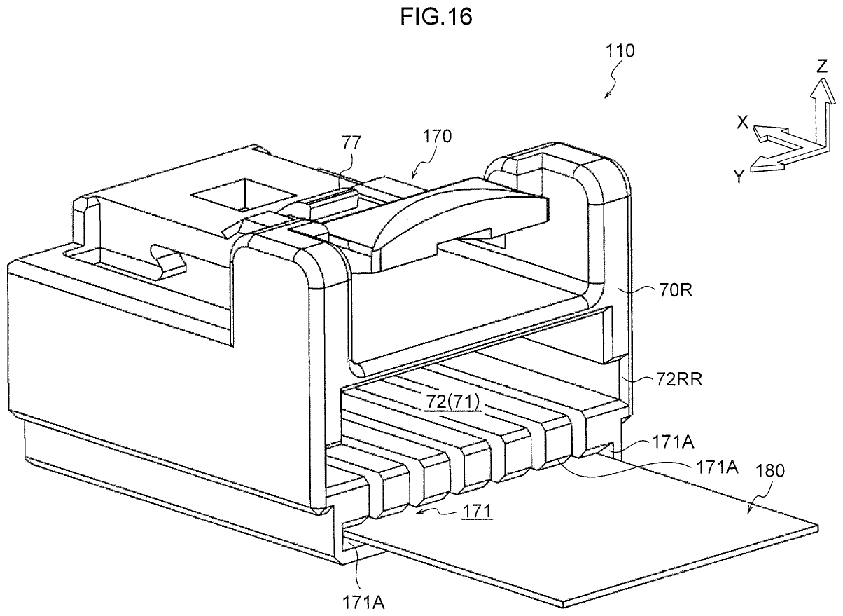

Lastly, explanation follows regarding a connector 110 (FPC connector) according to another exemplary embodiment of the present invention, with reference to FIG. 16 to FIG. 21.

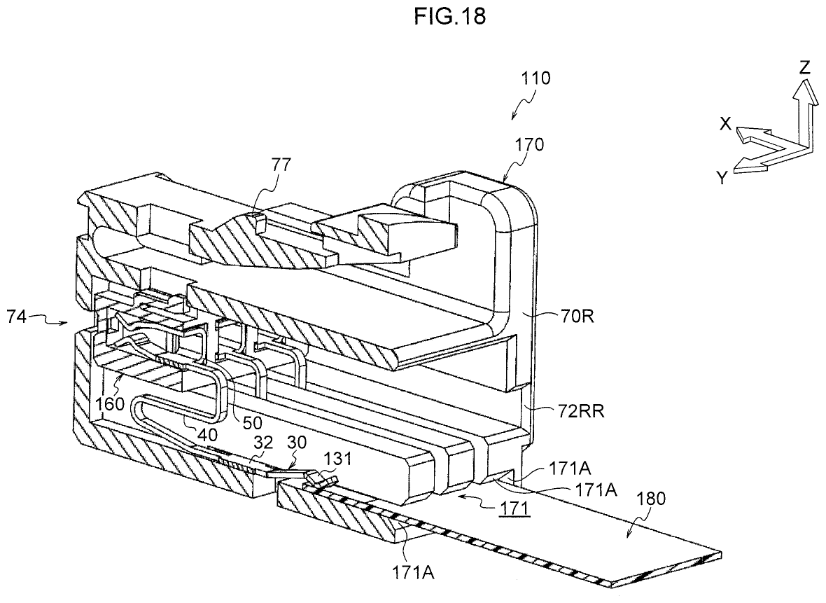

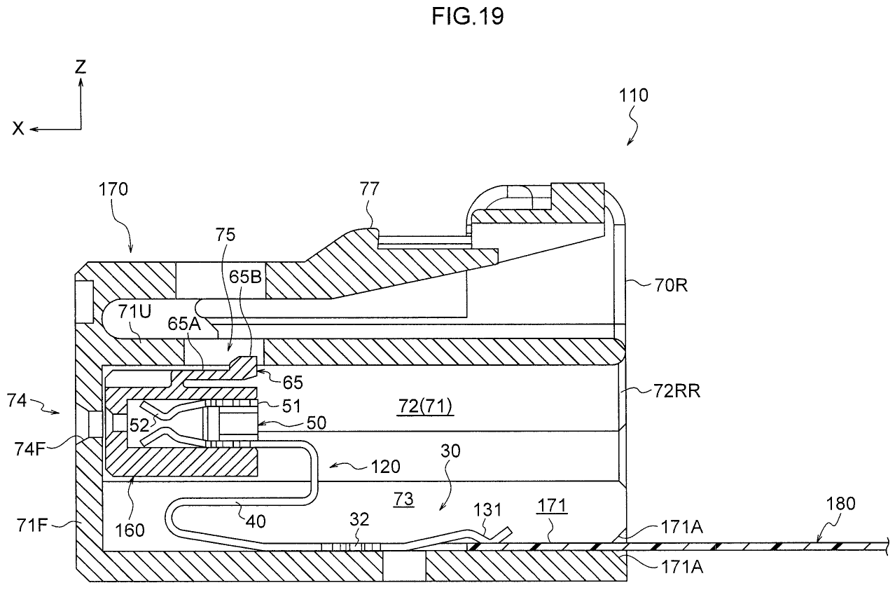

As illustrated in FIG. 16, FIG. 18, FIG. 19, and so on, the connector 110 according to the other exemplary embodiment differs from the exemplary embodiment described above in the point that the connection target (flexible wiring member) connected to one end side (a connector rear side) of a terminal 120 is an FPC 180 (flat wiring member) instead of the electric cable 80. Owing to this difference, the structure of a base end portion 30 of the terminal 120 and of a lower accommodation portion 73 of an outer housing 170 differ from those of the connector 10 of the exemplary embodiment described above. In the other exemplary embodiment, unlike the exemplary embodiment described above, the FPC 180, serving as a flexible wiring member and a flat wiring member, can be freely inserted or removed with respect to the connector 110 when in an assembled state.

Specific explanation follows regarding the connector 110.

Terminal 120

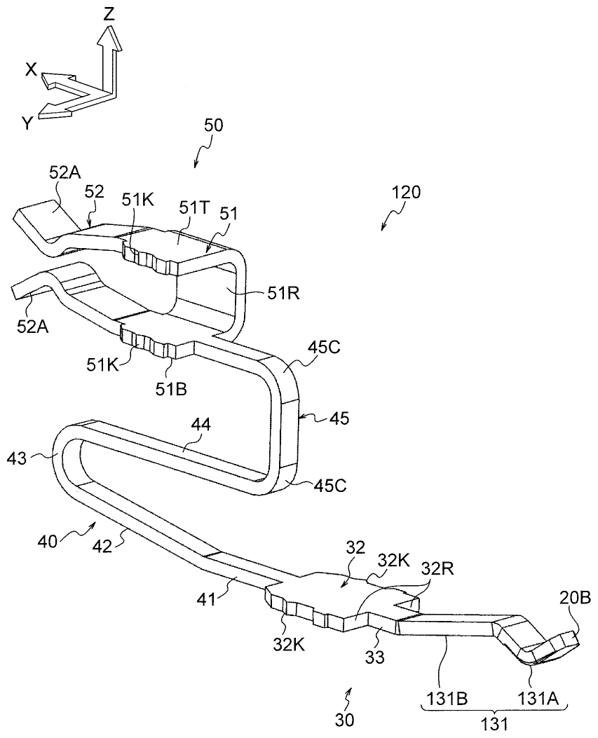

First, explanation follows regarding the terminals 120. The connector 110 is provided with plural (six) of the terminals 120. The plural terminals 120 have the same configuration as each other. FIG. 17 is a perspective view illustrating one terminal 120 out of the plural terminals 120.

The terminals 120 are, for example, formed by punching and then bending a sheet material. The material employed for the terminals 120 is a material with electrically conductive properties, such as a copper alloy.

The terminal 120 includes a base end portion 30, a spring portion 40, and a leading end portion 50 in this sequence from one end to the other end of the terminal 120. Out of the base end portion 30, the spring portion 40, and the leading end portion 50, the spring portion 40 and the leading end portion 50 have the same configurations as those of the terminal 20 of the exemplary embodiment described above, and explanation thereof is omitted.

Base End Portion 30

The base end portion 30 includes an FPC connection portion 131 and a base end side retained portion 32 in this sequence in progression from one end to the other end of the base end portion 30.

The FPC connection portion 131 is a portion for connecting to the FPC 180, and corresponds to a flexible wiring member connection portion of the present invention. The FPC connection portion 131 includes a contact portion 131A configured to make contact with the FPC 180, and an inclined portion 131B positioned between the contact portion 131A and the base end side retained portion 32. The contact portion 131A is bent so as to protrude downward, and is configured such that this curving protrusion makes contact with an upper face side of the FPC 180. The inclined portion 131B is inclined so as to be displaced upward on progression from the base end side retained portion 32 side toward the contact portion 131A side.

When the FPC 180 is plugged into the connector 110 (see FIG. 18 and FIG. 19), an end portion of the FPC 180 contacts a lower face of the contact portions 131A that are bent so as to protrude downward, causing the FPC connection portions 131 to undergo elastic deformation such that the FPC 180 enters to the lower side of the contact portions 131A. The contact portions 131A of the FPC connection portions 131 of the terminals 120 make elastic contact with an upper face of the FPC 180. As illustrated in FIG. 19, a portion of the FPC 180 that connects to the terminals 120 and the base end side retained portions 32 of the terminals 120 are positioned in the same plane as each other (a plane running parallel to the connector front-rear direction and the connector left-right direction).

The base end side retained portion 32 is a portion configured to be retained in the outer housing 170. The base end side retained portion 32 is configured in a flat plate shape with a plate thickness direction oriented in the up-down direction, and is formed with an anchor protrusion 32K on each width direction side. Note that the base end side retained portion 32 has the same structure as the base end side retained portion 32 of the exemplary embodiment described above.

A coupling portion 33 couples the FPC connection portion 131 and the base end side retained portion 32 together in the front-rear direction. The coupling portion 33 extends in a straight line along the front-rear direction and has a plate thickness direction oriented in the up-down direction. The coupling portion 33 has a uniform width dimension from one end to the other end. The width dimension of the coupling portion 33 is smaller than the width dimension of the base end side retained portion 32, and specifically is a dimension of no greater than one third thereof.

The other end (front end) of the coupling portion 33 is joined to a width direction central portion of a rear end of the base end side retained portion 32. The rear end of the base end side retained portion 32A is thereby formed with a pair of left and right press-fit shoulders 32R. The pair of left and right press-fit shoulders 32R are respectively formed on the left and right of the coupling portion 33. The press-fit shoulders 32R are configured by faces that face in the terminal rearward direction, and the base end side retained portion 32 can be pushed toward the front in an appropriate manner by abutting a tool or the like against the press-fit shoulders 32R.

Inner Housing 160

An inner housing 160 has the same structure as the inner housing 60 of the connector 10 according to the exemplary embodiment described above, and so explanation thereof is omitted.

Outer Housing 170

Explanation follows regarding the outer housing 170.

As illustrated in FIG. 16 and FIG. 19, the outer housing 170 includes an accommodation portion 71 configured by a rearward-opening space. The connector 110 is assembled by plugging in the inner housing 160 assembled with the plural terminals 120 toward the far end of the accommodation portion 71 through an opening portion in a rear face 70R of the outer housing 170.

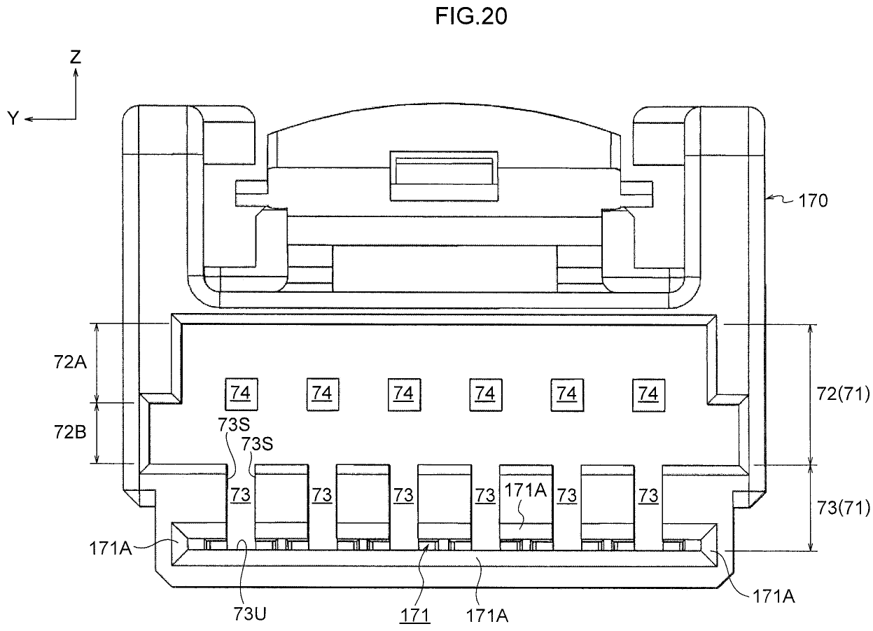

As illustrated in FIG. 20, the accommodation portion 71 is configured by an upper accommodation portion 72 joined-up in the width direction, and a lower accommodation portion 73 partitioned into plural (six) spaces.

Upper Accommodation Portion 72

The upper accommodation portion 72 has a similar configuration to the upper accommodation portion 72 of the outer housing 70 of the connector 10 according to the exemplary embodiment described above, and so explanation thereof is omitted.

Lower Accommodation Portion 73

As illustrated in FIG. 20, the lower accommodation portion 73 is configured by plural (six) terminal accommodation portions 73 (having the same reference numeral as the lower accommodation portion 73) arranged along the width direction. The plural terminal accommodation portions 73 are partitioned from each other and have the same structure as each other.

Each of the terminal accommodation portions 73 is configured by a space opening upward onto the upper accommodation portion 72 side and extending in the front-rear direction, and includes a bottom wall 73U and a pair of left and right side walls 73S.

As illustrated in FIG. 19, on progression from the rear toward the front, the FPC 180, the FPC connection portion 131 of the terminal 120, the base end side retained portion 32, and the spring portion 40 are disposed in this sequence inside each of the terminal accommodation portions 73 that extends in the front-rear direction.

The FPC 180 and the FPC connection portion 131 are disposed in a rear portion of the terminal accommodation portion 73. Namely, the outer housing 170 includes a flat wiring member placement portion 171 in which the FPC 180 serving as a flat wiring member is disposed in the rear portion of the terminal accommodation portion 73. Specifically, in the rear portion of the terminal accommodation portion 73, the plural (six) mutually partitioned terminal accommodation portions 73 are placed in communication with each other along the connector width direction. The plural terminal accommodation portions 73 are in communication with each other only at lower ends of the respective terminal accommodation portions 73. The plural terminal accommodation portions are completely partitioned from each other at a connector front side of the rear portion of the terminal accommodation portions 73 (at a connector front side of the portions in communication with each other along the connector width direction). The FPC 180 can accordingly not be plugged in further toward the front than the rear portions of the terminal accommodation portion 73. Namely, the outer housing 170 includes a plug-in range limiting portion configured to limit a plug-in range of the flat wiring member in the connector forward direction. A taper 171A configured to guide the FPC 180 into the connector is formed at the top, bottom, left, and right in the vicinity of an opening in (at a connector rear face side end portion of) the flat wiring member placement portion 171.

Other configurations are similar to those of the outer housing 70 of the exemplary embodiment described above, and are therefore appended with the same reference numerals in the drawings, and explanation thereof is omitted.

Operation and Advantageous Effects

Explanation follows regarding operation and advantageous effects of the present exemplary embodiment.

In the connector 110 according to the present exemplary embodiment, in an electrically connected state of the terminals 120 and the connection targets 94, the outer housing 170 and the counterpart housing 92 are in a fitted state. There is a possibility that play may be present between the outer housing 170 and the counterpart housing 92.

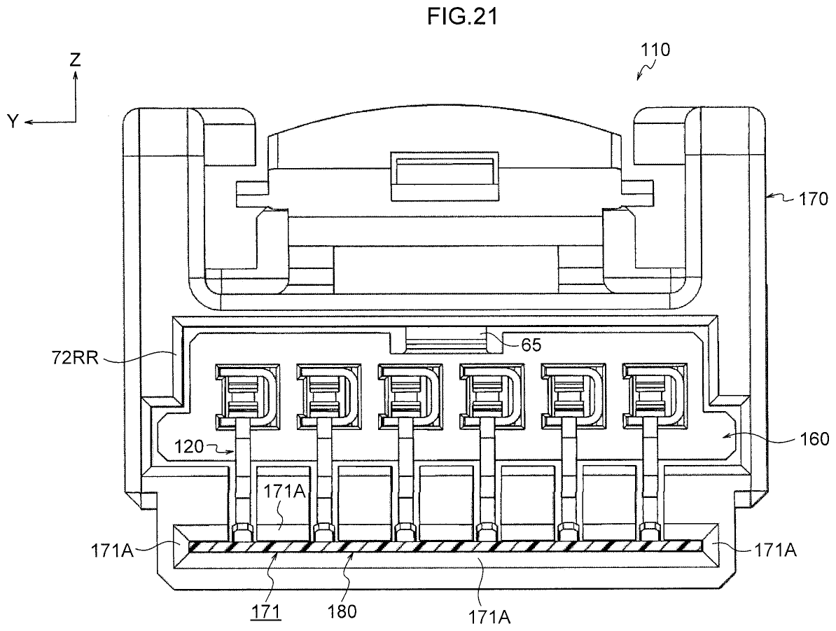

Note that as illustrated in FIG. 19, in the connector 110 according to the present exemplary embodiment, the leading end portion 50 of each of the terminals 120 includes the contact portion 52 configured to contact the connection target 94 that is inserted and removed along the connector front-rear direction, and the leading end side retained portion 51 retained in the inner housing 160. Namely, the leading end portion 50 of the terminal 120 contacts the connection target 94 and is also retained in the inner housing 160. As illustrated in FIG. 19 and FIG. 21, the inner housing 160 that retains the leading end portion 50 is movable with respect to the outer housing 170 within a predetermined movable region in the front-rear direction, left-right direction, and up-down direction of the connector.

Accordingly, even if play is present between the outer housing 170 and the counterpart housing 92, the inner housing 160 is movable with respect to the outer housing 170, thereby suppressing sliding of the contact point between the connection target 94 and the contact portion 52.

Moreover, the base end portion 30 of the terminal 120 includes the FPC connection portion 131 configured to connect to the FPC 180 serving as a flexible wiring member, the FPC connection portion 131 serving as a flexible wiring member connection portion, and the base end side retained portion 32 retained in the outer housing 170. Namely, the base end portion 30 of the terminal 120 is connected to the FPC 180 and is also retained in the outer housing 170. Any flapping of the FPC 180 is therefore transmitted so as to affect the base end portion 30 of the terminal 120.

However, in the connector 110 according to the present exemplary embodiment, the terminal 120 includes the spring portion 40 positioned between the leading end portion 50 and the base end portion 30.

Accordingly, even if the flapping of the FPC 180 pushes in or tugs on the terminal 120, the spring portion 40 positioned between the base end portion 30 and the leading end portion 50 undergoes elastic deformation, enabling the flapping of the FPC 180 to be suppressed from affecting the leading end portion 50 of the terminal 120. Sliding of the contact point caused by flapping of the FPC 180 can thus be suppressed.

Other operation and advantageous effects stem from configurations similar to those in the exemplary embodiment described above, and so explanation thereof is omitted. Note that the FPC 180 described above in the other exemplary embodiment may be substituted for an FFC.

### EXPLANATION OF THE REFERENCE NUMERALS

10 connector

20 terminal

30 base end portion

31 electric cable connection portion (flexible wiring member connection portion)

32 base end side retained portion

32R press-fit shoulder

40 spring portion

43 first bent portion (doubling-back portion)

44 second linear portion (doubling-back portion)

45 second bent portion (doubling-back portion)

50 leading end portion

51 leading end side retained portion

52 contact portion

60 inner housing

65 anchored portion

70 outer housing

70R rear face (connector rear side face of outer housing)

71 accommodation portion

72F housing accommodation portion

72RR housing assembly opening

73B terminal retention portion (base end accommodation portion)

73C electric cable placement portion (base end accommodation portion)

73U bottom wall (bottom face)

75 anchor portion

76 tool insertion hole

80 electric cable (flexible wiring member)

92 counterpart housing

94 connection target

AX1 insertion-removal axis

AX2 electric cable connection axis (connection axis of flexible wiring member connection portion)

110 connector

120 terminal

131 FPC connection portion (flexible wiring member connection portion)

160 inner housing

170 outer housing

180 FPC (flexible wiring member)

The disclosure of Japanese Patent Application No. 2017-106298, filed on May 30, 2017, is incorporated in its entirety by reference herein.

1. A connector comprising:
an outer housing that fits together with a counterpart housing configured to retain a connection target;
an inner housing that is accommodated in the outer housing so as to be movable with respect to the outer housing, in a predetermined movable region in a connector front-rear direction; and
a terminal accommodated in the outer housing;
the terminal including a leading end portion, a base end portion, and a spring portion positioned between the leading end portion and the base end portion;
the leading end portion including a contact portion configured to contact the connection target, which is insertable and removable in the connector front-rear direction, and a leading end side retained portion configured to be retained in the inner housing; and
the base end portion including a flexible wiring member connection portion that connects to a flexible wiring member, and a base end side retained portion configured to be retained in the outer housing.

2. The connector of claim 1, wherein:
the outer housing includes a housing assembly opening formed at a connector rear side face of the outer housing and adjacent to a housing accommodation portion in which the inner housing is accommodated, and an anchor portion provided at the housing accommodation portion;
the inner housing includes an anchored portion that undergoes elastic deformation in a case in which the inner housing is pushed toward the housing accommodation portion through the housing assembly opening, the elastic deformation being released upon the anchored portion reaching the anchor portion such that the anchored portion is anchored by the anchor portion; and
the anchored portion limits a movement range of the inner housing in a connector rearward direction due to being anchored by the anchor portion.

3. The connector of claim 1, wherein:
the base end side retained portion is retained in the outer housing by being press-fitted into the outer housing;
the base end side retained portion includes a press-fit shoulder that is pushed in toward a connector front from a connector rear during press-fitting of the base end side retained portion; and
the base end side retained portion is positioned between the flexible wiring member connection portion and the spring portion.

4. The connector of claim 3, wherein the outer housing includes a tool insertion hole that penetrates a bottom face of a base end accommodation portion that accommodates the base end portion, and that places the base end accommodation portion in communication with a space at an exterior of the outer housing.

5. The connector of claim 1, wherein an insertion-removal axis of the contact portion is substantially parallel to a connection axis of the flexible wiring member connection portion, and is positionally offset from the connection axis of the flexible wiring member connection portion, in a direction orthogonal to the connector front-rear direction.

6. The connector of claim 5, wherein the spring portion includes a doubling-back portion that is doubled back in the connector rearward direction, which is an insertion direction of the connection target.
